(19) United States
(12) Patent Application Publication
(10) Pub. No.: US 2025/0081081 A1
(43) Pub. Date: Mar. 6, 2025

(54) MULTIPLE PATH OVER UE-TO-NETWORK AND NG-UU

(71) Applicant: Intel Corporation, Santa Clara, CA (US)

(72) Inventor: Chang Hong Shan, Shanghai (CN)

(21) Appl. No.: 18/726,543

(22) PCT Filed: Mar. 9, 2023
(86) PCT No.: PCT/US2023/014881

§ 371 Date: Jul. 3, 2024

(30) Foreign Application Priority Data
Mar. 18, 2022 (WO) PCT/CN2022/081666
Mar. 28, 2022 (WO) PCT/CN2022/083350

(51) Int. Cl. H04W 40/22; H04W 88/04

(52) U.S. Cl. CPC H04W 40/22; H04W 88/04

(57) ABSTRACT

An apparatus and system of providing multi-path transmissions are described. A user equipment (UE) sends a Multi-path Policy Provisioning Request in a UE Policy Container to a policy control function (PCF). The PCF provisions a UE route selection policy (URSP) to the UE including a Multi-Path preference in an Access Type preference or multi-path parameter of a Route Selection Descriptor of a URSP rule. The Multi-Path preference indicates a preferred path over a Uu interface and Layer-2 or Layer-3 UE-to-Network Relay. The UE determines packet data unit (PDU) establishment additionally based on path availability, as well as ProSe Layer-3 UE-to-Network Relay Offload indication and ProSe Policy. The Multi-path Policy Provisioning Request is earned in a Registration Request message or UE Policy Provisioning Request message.

### PRIORITY CLAIM

This application claims the benefit of priority to International Application No. PCT/CN2022/081666, filed Mar. 18, 2022, and International Application No. PCT/CN2022/083350, filed Mar. 28, 2022, each of which is incorporated herein by reference in its entirety.

### TECHNICAL FIELD

Embodiments pertain to wireless communications. In particular, some embodiments relate to multi-path transmissions in wireless networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to multi-path transmission, which is of particular importance at increasingly higher frequencies. In particular, the use of a user equipment (UE)-to-network relay as an alternative path for specific types of services continues to be investigated.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates multi-path transmission using a UE-to-Network relay in accordance with some embodiments.

FIG. 4 illustrates a UE Configuration Update procedure in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

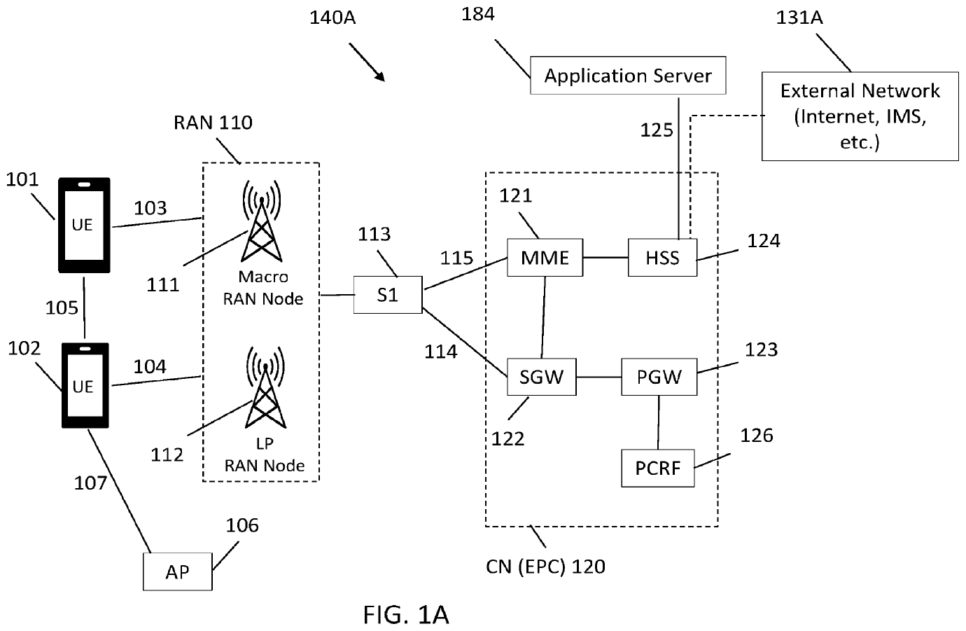

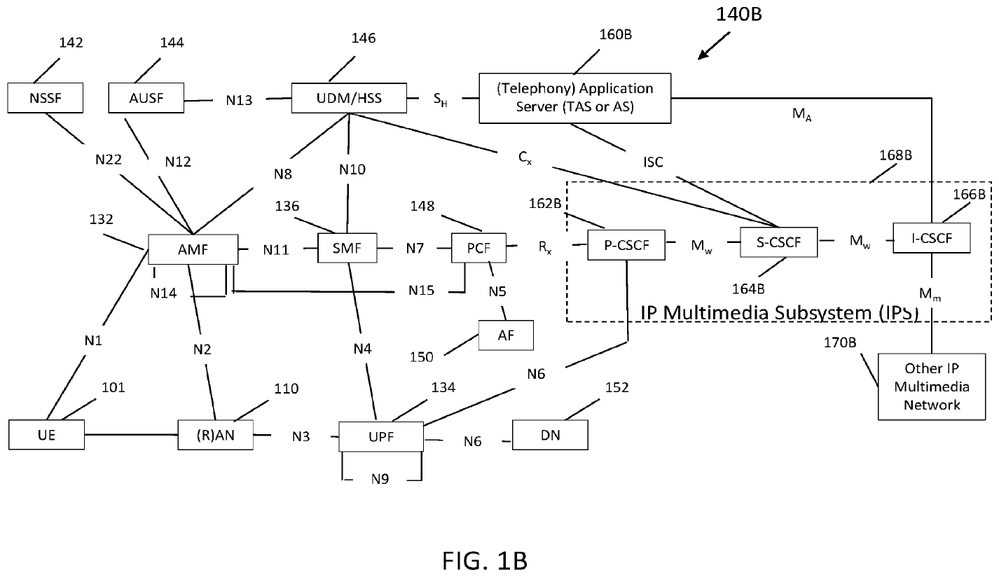

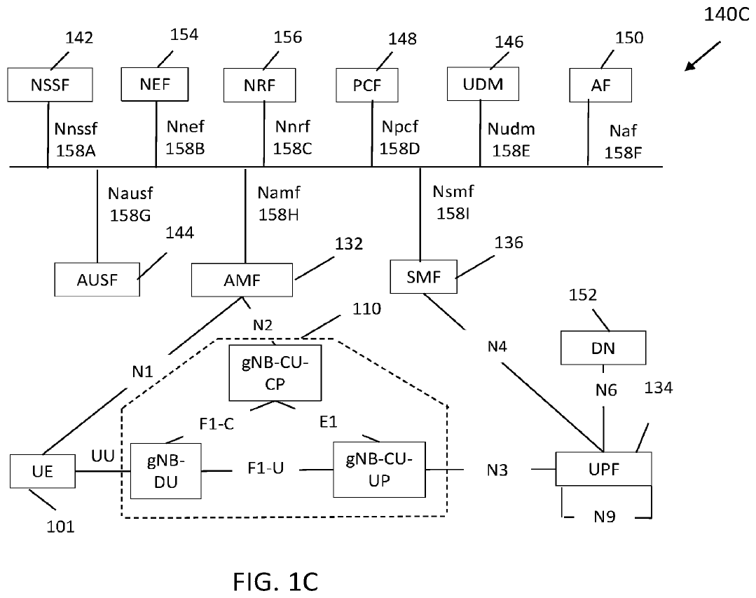

FIG. 1A illustrates an architecture of a network in accordance with some aspects. The network 140A includes 3GPP LTE/4G and NG network functions that may be extended to 6G and later generation functions. Accordingly, although 5G will be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHZ, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrow band (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units-a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signalling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signalling connection and UE-associated services that are related to a single UE and are associated with a UE-associated signalling connection that is maintained for the UE.

The F1 interface may be disposed between the CU and the DU. The CU may control the operation of the DU over the F1 interface. As the signalling in the gNB is split into control plane and user plane signalling, the F1 interface may be split into the F1-C interface for control plane signalling between the gNB-DU and the gNB-CU-CP, and the F1-U interface for user plane signalling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFiR) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as E2 nodes, base stations (BSs). NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signalling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrow band-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard. 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146). Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

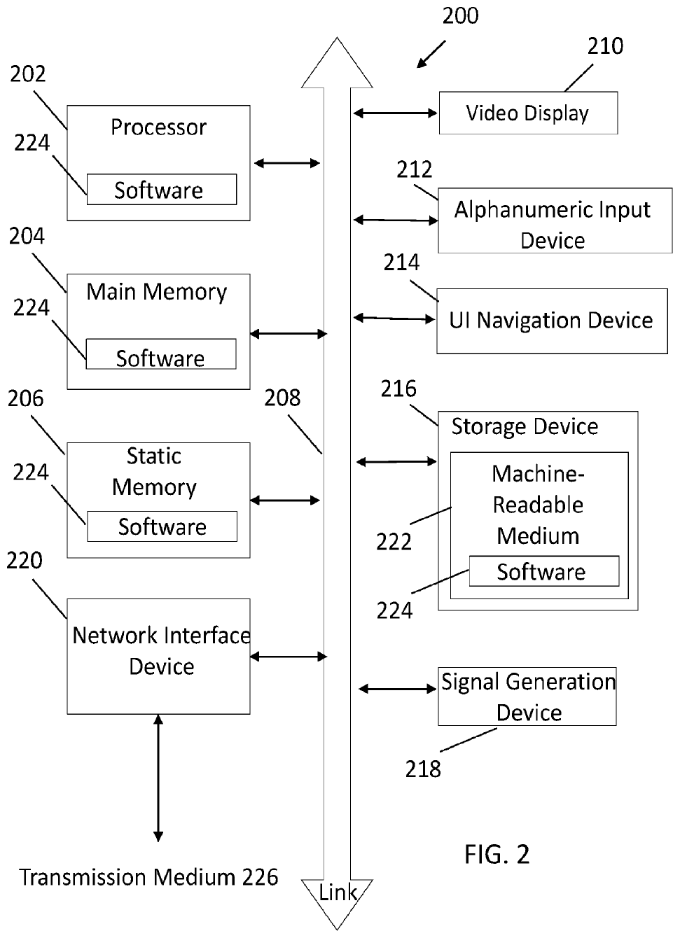

FIG. 2 illustrates a block diagram of a communication device in accordance with some embodiments, such as an evolved Node-B (eNB), a new generation Node-B (gNB) (or another RAN node), an access point (AP), a wireless station (STA), a mobile station (MS), or user equipment (UE), in accordance with some aspects and to perform one or more of the techniques disclosed herein. In alternative aspects, the communication device 200 may operate as a standalone device or may be connected (e.g., networked) to other communication devices. The communication device may be any machine capable of executing instructions (sequential or otherwise) that specify actions to be taken by that machine. For example, the communication device 200 may be implemented as one or more of the devices shown in FIGS. 1A-IC. Note that communications described herein may be encoded before transmission by the transmitting entity (e.g., UE. gNB) for reception by the receiving entity (e.g., gNB. UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax. IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G). Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9) (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra. LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G). Code division multiple access 2000 (Third generation) (CDMA2000 (3G)). Evolution-Data Optimized or Evolution-Data Only (EV-DO). Advanced Mobile Phone System (1st Generation) (AMPS (1G)), Total Access Communication System/Extended Total Access Communication System (TACS/ETACS). Digital AMPS (2nd Generation) (D-AMPS (2G)), Push-to-talk (PTT). Mobile Telephone System (MTS), Improved Mobile Telephone System (IMTS). Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHZ and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V21) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5.875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHZ, 3.4-3.6 GHZ, 3.6-3.8 GHZ and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHZ (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHZ and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHZ, 42-42.5 GHZ, 57-64 GHZ, 71-76 GHZ, 81-86 GHZ and 92-94 GHZ, etc), the ITS (Intelligent Transport Systems) band of 5.9 GHZ (typically 5.85-5.925 GHZ) and 63-64 GHz, bands currently allocated to WiGig such as WiGig Band 1 (57.24-59.40 GHz), WiGig Band 2 (59.40-61.56 GHZ) and WiGig Band 3 (61.56-63.72 GHz) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHZ spectrum, while EU (ETSI EN 302 567 and ETSI EN 301 217-2 for fixed P2P) allocates total 9 GHz spectrum), the 70.2 GHZ-71 GHz band, any band between 65.88 GHz and 71 GHZ, bands currently allocated to automotive radar applications such as 76-81 GHZ, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs. NR or gNBs—note that this term is typically used in the context of 3GPP 5G and 6G communication systems, etc. Still, a UE may take this role as well and act as an AP, eNB, or gNB: that is some or all features defined for network equipment may be implemented by a UE.

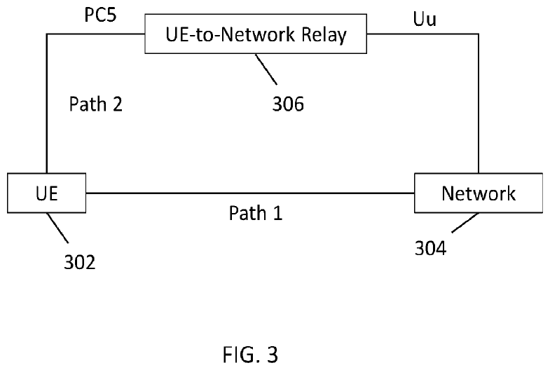

As above, the use of multi-path transmission may improve communication characteristics under certain conditions. In particular, multi-path transmission using only one direct network communication path and only one indirect network communication path with UE-to-Network Relay can be used to improve reliability or data rates for the Remote UE. FIG. 3 illustrates multi-path transmission using a UE-to-Network relay in accordance with some embodiments. As illustrated in FIG. 3, a UE 302 may use path #1 and path #2 for multi-path transmission, where path #1 is direct network communication path between the UE 302 and the network 304 (NG-RAN) to which the UE 302 is connected, and path #2 is indirect network communication path using a UE-to-Network Relay 306 between the UE 302 and the network 304. The UE 302 is connected to the UE-to-Network Relay 306 via the PC5 interface and the UE-to-Network Relay 306 is connected to the network 304 via the Uu interface.

A number of aspects may be studied to enable multi-path transmission, including whether and how to enhance existing procedures to establish/modify/release a connection for multi-path transmission, and whether and how the network authorizes and the triggers for connection establishment for multi-path transmission. The latter of these may include whether and how to authorize a remote UE to use the multi-path transmission for specific Proximity Services (ProSe) services, what information is to be used for, and how does a remote UE or UE-to Network Relay or the network, trigger the multi-path connection establishment, and how to provide/update the rules for multiple-path transmission.

### Embodiment 1:6.1.1 Extending Access Type Preference in the Route Selection Descriptor

The UE route selection policy (URSP) includes a prioritized list of URSP rules. The structure of the URSP rules is described in Table 6.6.2.1-2 and Table 6.6.2.1-3.

TABLE 6.6.2.1-2
UE Route Selection Policy Rule

| | | | PCF | |
|---|---|---|---|---|
| | | | permitted | |
| | | | to modify | |
| Information | | | in a UE | |
| name | Description | Category | context | Scope |
| Rule | Determines the | Mandatory | Yes | UE |
| Precedence | order the URSP rule | (NOTE 1) | | context |
| | is enforced in the | | | |
| | UE. | | | |
| Traffic | This part defines | Mandatory | | |
| descriptor | the Traffic | (NOTE 3) | | |
| | descriptor | | | |
| | components for the | | | |
| | URSP rule. | | | |
| Application | It consists of OSId | Optional | Yes | UE |
| descriptors | and OSAppId(s). | | | context |
| | (NOTE 2) | | | |
| IP | Destination IP 3 | Optional | Yes | UE |
| descriptors | tuple(s) (IP address | | | context |
| (NOTE 5) | or IPv6 network | | | |
| | prefix, port number, | | | |
| | protocol ID of the | | | |
| | protocol above IP). | | | |
| Domain | FQDN(s) or a | Optional | Yes | UE |
| descriptors | regular expression | | | context |
| | which are used as a | | | |
| | domain name | | | |
| | matching criteria | | | |
| | (NOTE 6). | | | |
| Non-IP | Descriptor(s) for | Optional | Yes | UE |
| descriptors | destination | | | context |
| (NOTE 5) | information of non- | | | |
| | IP traffic | | | |
| DNN | This is matched | Optional | Yes | UE |
| | against the DNN | | | context |
| | information | | | |
| | provided by the | | | |
| | application. | | | |
| Connection | This is matched | Optional | Yes | UE |
| Capabilities | against the | | | context |
| | information | | | |
| | provided by a UE | | | |
| | application when it | | | |
| | requests a network | | | |
| | connection with | | | |
| | certain capabilities. | | | |
| | (NOTE 4) | | | |
| Rule | Determines the | Mandatory | Yes | UE |
| Precedence | order the URSP rule | (NOTE 1) | | context |
| | is enforced in the | | | |
| | UE. | | | |
| List of | A list of Route | Mandatory | | |
| Route | Selection | | | |
| Selection | Descriptors. The | | | |
| Descriptors | components of a | | | |
| | Route Selection | | | |
| | Descriptor are | | | |
| | described in table | | | |
| | 6.6.2.1-3. | | | |

NOTE 1:
Rules in a URSP shall have different precedence values.
NOTE 2:
The information is used to identify the Application(s) that is(are) running on the UE's OS. The OSId does not include an OS version number. The OSAppId does not include a version number for the application.
NOTE 3:
At least one of the Traffic descriptor components shall be present.
NOTE 4:
The format and some values of Connection Capabilities, e.g. “ims”, “mms”, “internet”, etc., are defined in TS 24.526 [19]. More than one connection capabilities value can be provided.
NOTE 5:
A URSP rule cannot contain the combination of the Traffic descriptor components IP descriptors and Non-IP descriptors.
NOTE 6:
The match of this traffic descriptor does not require successful DNS resolution of the FQDN provided by the UE Application.

A Layer 2 UE-to-Network Relay is treated as 3GPP access per TS 23.304. In order to authorize the multiple paths via a layer 2 UE-to-Network Relay and direct Uu interface, the Access Type Preference in the Route Selection Descriptor (RSD) of the URSP rule is extended as indicated in Table 6.6.2.1-3 below:

TABLE 6.6.2.1-3
Route Selection Descriptor

| | | | PCF | |
|---|---|---|---|---|
| | | | permitted | |
| Information | | | to modify | |
| name | Description | Category | in URSP | Scope |
| Route | Determines the | Mandatory | Yes | UE |
| Selection | order in which the | (NOTE 1) | | context |
| Descriptor | Route Selection | | | |
| Precedence | Descriptors are to be | | | |
| | applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value | Optional | Yes | UE |
| Slice | or a list of values of | (NOTE 3) | | context |
| Selection | S-NSSAI(s). | | | |
| DNN | Either a single value | Optional | Yes | UE |
| Selection | or a list of values of | | | context |
| | DNN(s). | | | |
| PDU | One single value of | Optional | Yes | UE |
| Session | PDU Session Type | (NOTE 8) | | context |
| Type | | | | |
| Selection | | | | |
| Non- | Indicates if the | Optional | Yes | UE |
| | traffic of the | (NOTE 4) | | context |
| Seamless | matching | | | |
| Offload | application is to be | | | |
| indication | offloaded to non- | | | |
| | 3GPP access outside | | | |
| | of a PDU Session. | | | |
| ProSe | Indicates if the | Optional | Yes | UE |
| Layer-3 UE- | traffic of the | (NOTE 4) | | context |
| to-Network | matching | | | |
| Relay | application is to be | | | |
| Offload | sent via a ProSe | | | |
| indication | Layer-3 UE-to- | | | |
| | Network Relay | | | |
| | outside of a PDU | | | |
| | session. | | | |
| Access Type | Indicates the | Optional | Yes | UE |
| preference | preferred Access | | | context |
| | Type (3GPP or non- | | | |
| | 3GPP or Multi- | | | |
| | Access or Multi- | | | |
| | Path) when the UE | | | |
| | establishes a PDU | | | |
| | Session for the | | | |
| | matching | | | |
| | application. | | | |
| PDU | An indication | Optional | Yes | UE |
| Session Pair | shared by redundant | | | context |
| ID | PDU Sessions as | | | |
| | described in | | | |
| | clause 5.33.2.1 of | | | |
| | TS 23.501 [2]. | | | |
| RSN | The RSN as | Optional | Yes | UE |
| | described in | | | context |
| | clause 5.33.2.1 of | | | |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. | | | |
| | The RSD is not | | | |
| | considered to be | | | |
| | valid if the current | | | |
| | time is not in the | | | |
| | time window. | | | |
| Location | The UE location | Optional | Yes | UE |
| Criteria | where the matching | | | context |
| | traffic is allowed. | | | |
| | The RSD rule is not | | | |
| | considered to be | | | |
| | valid if the UE | | | |
| | location does not | | | |
| | match the location | | | |
| | criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
When the PDU Session Type is “Ethernet” or “Unstructured”, this component shall be present.

Access Type Preference (ATP): if the UE is to establish a packet data unit (PDU) Session when the rule is applied, the ATP indicates the Access Type (3GPP or non-3GPP or multi-access or multi-path) on which the PDU Session should be established. The type “Multi-Access” (MA) indicates that the PDU Session should be established as a MA PDU Session, using both 3GPP access and non-3GPP access. The type “Multi-Path” indicates that the PDU Session should be established as a Multi-path PDU Session over both Layer-2 UE-to-Network Relay and 3GPP access if both are available. 3GPP access is direct Uu interface access between the UE and the RAN (e.g., gNB).

The URSP is provisioned by the PCF to the UE using the procedures defined in TS 23.502 clause 4.2.4.2 and 4.2.4.3.

When the UE has a Layer-2 UE-to-Network Relay path available and establishes a PDU Session, the UE evaluates the matched URSP rule for application traffic and decides whether to use the Multi-Path PDU Session for the application traffic based on the Access Type preference in the Route Selection Descriptor of a URSP rule.

Each URSP rule contains a Traffic descriptor (containing one or more components described in Table 6.6.2.1-2) that determines when the rule is applicable. A URSP rule is determined to be applicable when every component in the Traffic descriptor matches the corresponding information from the application. A URSP rule is determined not to be applicable when, for any given component in the Traffic descriptor: no corresponding information from the application is available; or the corresponding information from the application does not match any of the values in the Traffic descriptor component.

If a URSP rule is provided that contains a Traffic descriptor with two or more components, URSP rule(s) with lower precedence and a Traffic descriptor with less components may be provided in order to increase the likelihood of URSP rule matching for a particular application.

Each URSP rule contains a list of Route Selection Descriptors containing one or multiple Route Selection Descriptors each having a different Route Selection Descriptor Precedence value. A Route Selection Descriptor contains one or more of the following components in addition to the ATP:

Session and Service Continuity (SSC) Mode: Indicates that the traffic of the matching application is routed via a PDU Session supporting the included SSC Mode.

Network Slice Selection: Indicates that the traffic of the matching application shall be routed via a PDU Session supporting any of the included S-NSSAIs, see clause 5.15.4 in TS 23.501. It includes one or more S-NSSAI(s).

DNN Selection: Indicates that the traffic of the matching application shall be routed via a PDU Session supporting any of the included DNNs. It includes one or more DNN(s). If a DNN Selection component is provided in the Route Selection Descriptor then the UE uses any of the DNNs of the DNN Selection component, instead of the DNN requested by the application for the PDU Session that is used to route the traffic of the matching application. If there is no DNN Selection component in the Route Selection Descriptor, then the UE uses the DNN requested by the application for the PDU Session that is used to route the traffic of the matching application.

PDU Session Type Selection: Indicates that the traffic of matching application is routed via a PDU Session supporting the included PDU Session Type. The possible PDU Session Types are defined in clause 5.6.10 in TS 23.501.

Non-Seamless Offload indication: Indicates that traffic of the matching application is to be offloaded to non-3GPP access outside of a PDU Session when the rule is applied. If this component is present in a Route Selection Descriptor, no other components are included in the Route Selection Descriptor.

ProSe Layer-3 UE-to-Network Relay Offload indication: Indicates that the traffic of the matching application is to be sent via a ProSe Layer-3 UE-to-Network Relay outside of a PDU Session when the rule is applied. If this indication is absent, then the traffic matching of the URSP rule is not sent via a ProSe Layer-3 UE-to-Network Relay outside of a PDU Session. If this component is present in a Route Selection Descriptor, no other components are included in the Route Selection Descriptor.

PDU Session Pair ID: An indication shared by redundant PDU Sessions as described in clause 5.33.2.1 of TS 23.501.

RSN: The RSN for redundant PDU Sessions as described in clause 5.33.2.1 of TS 23.501.

Time Window: The Route Selection Descriptor is not considered valid unless the UE is in the time window.

Location Criteria: The Route Selection Descriptor is not considered valid unless the UE's location matches the Location Criteria.

In the case of network rejection of the PDU Session Establishment Request, the UE may trigger a new PDU Session establishment based on the rejection cause and the URSP policy.

When the PCF provisions URSP rules to the UE, one URSP rule with a “match all” Traffic descriptor may be included.

The URSP rule with the “match all” Traffic descriptor is used to route the traffic of applications which do not match any other URSP rules and is therefore be evaluated as the last URSP rule, i.e., with lowest priority. There is only one Route Selection Descriptor in this URSP rule. The Route Selection Descriptor in this URSP rule includes at most one value for each Route Selection Component.

### Embodiment 2:6.1.2 Define a New Multi-Path Parameter in the RSD

A Layer 2 UE-to-Network Relay is treated as 3GPP access per 23.304. Thus, if the Access Type preference in the RSD of a URSP rule indicates 3GPP Access, the UE is allowed to use a Layer-2 UE-to-Network Relay based on the ProSe Policy for Layer-2 Relay access authorization. In order to authorize the multiple paths via a layer 2 UE-to-Network Rely and direct Uu interface, a new “Multi-Path” parameter is included in the Route Selection Descriptor of the URSP rule as in table 6.6.2.1-3 below:

TABLE 6.6.2.1-3
Route Selection Descriptor

| | | | PCF | |
|---|---|---|---|---|
| | | | permitted | |
| Information | | | to modify | |
| name | Description | Category | in URSP | Scope |
| Route | Determines the | Mandatory | Yes | UE |
| Selection | order in which the | (NOTE 1) | | context |
| Descriptor | Route Selection | | | |
| Precedence | Descriptors are to be | | | |
| | applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value | Optional | Yes | UE |
| Slice | or a list of values of | (NOTE 3) | | context |
| Selection | S-NSSAI(s). | | | |
| DNN | Either a single value | Optional | Yes | UE |
| Selection | or a list of values of | | | context |
| | DNN(s). | | | |
| PDU | One single value of | Optional | Yes | UE |
| Session | PDU Session Type | (NOTE 8) | | context |
| Type | | | | |
| Selection | | | | |
| Non- | Indicates if the | Optional | Yes | UE |
| Seamless | traffic of the | (NOTE 4) | | context |
| | matching | | | |
| Offload | application is to be | | | |
| indication | offloaded to non- | | | |
| | 3GPP access outside | | | |
| | of a PDU Session. | | | |
| ProSe | Indicates if the | Optional | Yes | UE |
| Layer-3 UE- | traffic of the | (NOTE 4) | | context |
| to-Network | matching | | | |
| Relay | application is to be | | | |
| Offload | sent via a ProSe | | | |
| indication | Layer-3 UE-to- | | | |
| | Network Relay | | | |
| | outside of a PDU | | | |
| | session. | | | |
| Access Type | Indicates the | Optional | Yes | UE |
| preference | preferred Access | | | context |
| | Type (3GPP or non- | | | |
| | 3GPP or Multi- | | | |
| | Access) when the | | | |
| | UE establishes a | | | |
| | PDU Session for the | | | |
| | matching | | | |
| | application. | | | |
| Multi-Path | Indicates the Multi- | Optional | Yes | UE |
| preference | Path PDU Sessions | | | context |
| | via direct Uu and | | | |
| | Layer-2 UE-to- | | | |
| | Network Relay is | | | |
| | preferred | | | |
| PDU | An indication | Optional | Yes | UE |
| Session Pair | shared by redundant | | | context |
| ID | PDU Sessions as | | | |
| | described in | | | |
| | clause 5.33.2.1 of | | | |
| | TS 23.501 [2]. | | | |
| RSN | The RSN as | Optional | Yes | UE |
| | described in | | | context |
| | clause 5.33.2.1 of | | | |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. | | | |
| | The RSD is not | | | |
| | considered to be | | | |
| | valid if the current | | | |
| | time is not in the | | | |
| | time window. | | | |
| Location | The UE location | Optional | Yes | UE |
| Criteria | where the matching | | | context |
| | traffic is allowed. | | | |
| | The RSD rule is not | | | |
| | considered to be | | | |
| | valid if the UE | | | |
| | location does not | | | |
| | match the location | | | |
| | criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
When the PDU Session Type is “Ethernet” or “Unstructured”, this component shall be present.

As shown, one difference between this embodiment and the last embodiment is that in this embodiment, the ATP remains the same and instead a Multi-Path preference field is added. Multi-Path preference: If the UE is to establish PDU Sessions, the UE indicates such an operation via the direct Uu interface and Layer-2 UE-to-Network Relay is preferred.

When the UE has a Layer-2 UE-to-Network Relay path available and establishes a PDU Session, the UE evaluates the matched URSP rule for application traffic and decides whether to use Multi-Path PDU Session for the application traffic based on the Multi-Path preference in the Route Selection Descriptor of a URSP rule.

### Embodiment 3:6.1.3 Layer-3 UE-to-Network Relay: Define a New Multi-Path Parameter in the RSD

A Layer 3 UE-to-Network Relay is guided as ProSe Layer-3 UE-to-Network Relay Offload indication per 23.503, the UE is allowed to use Layer-3 UE-to-Network Relay based on the ProSe Policy for Layer-3 Relay access authorization. In order to authorize the multiple paths via a layer 3 UE-to-Network Relay and direct Uu interface, a new “Multi-Path” parameter is included in the Route Selection Descriptor of the URSP rule as in Table 6.6.2.1-3 below:

TABLE 6.6.2.1-3
Route Selection Descriptor

| | | | PCF | |
|---|---|---|---|---|
| | | | permitted | |
| Information | | | to modify | |
| name | Description | Category | in URSP | Scope |
| Route | Determines the | Mandatory | Yes | UE |
| Selection | order in which the | (NOTE 1) | | context |
| Descriptor | Route Selection | | | |
| Precedence | Descriptors are to be | | | |
| | applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value | Optional | Yes | UE |
| Slice | or a list of values of | (NOTE 3) | | context |
| Selection | S-NSSAI(s). | | | |
| DNN | Either a single value | Optional | Yes | UE |
| Selection | or a list of values of | | | context |
| | DNN(s). | | | |
| PDU | One single value of | Optional | Yes | UE |
| Session | PDU Session Type | (NOTE 8) | | context |
| Type | | | | |
| Selection | | | | |
| Non- | Indicates if the | Optional | Yes | UE |
| Seamless | traffic of the | (NOTE 4) | | context |
| Offload | matching | | | |
| indication | application is to be | | | |
| | offloaded to non- | | | |
| | 3GPP access outside | | | |
| | of a PDU Session. | | | |
| ProSe | Indicates if the | Optional | Yes | UE |
| Layer-3 UE- | traffic of the | (NOTE 4) | | context |
| to-Network | matching | | | |
| Relay | application is to be | | | |
| Offload | sent via a ProSe | | | |
| indication | Layer-3 UE-to- | | | |
| | Network Relay | | | |
| | outside of a PDU | | | |
| | session. | | | |
| Access Type | Indicates the | Optional | Yes | UE |
| preference | preferred Access | | | context |
| | Type (3GPP or non- | | | |
| | 3GPP or Multi- | | | |
| | Access) when the | | | |
| | UE establishes a | | | |
| | PDU Session for the | | | |
| | matching | | | |
| | application. | | | |
| Multi-Path | Indicates the Multi- | Optional | Yes | UE |
| preference | Path PDU Sessions | | | context |
| | via direct Uu and | | | |
| | Layer-3 UE-to- | | | |
| | Network Relay is | | | |
| | preferred | | | |
| PDU | An indication | Optional | Yes | UE |
| Session Pair | shared by redundant | | | context |
| ID | PDU Sessions as | | | |
| | described in | | | |
| | clause 5.33.2.1 of | | | |
| | TS 23.501 [2]. | | | |
| RSN | The RSN as | Optional | Yes | UE |
| | described in | | | context |
| | clause 5.33.2.1 of | | | |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. | | | |
| | The RSD is not | | | |
| | considered to be | | | |
| | valid if the current | | | |
| | time is not in the | | | |
| | time window. | | | |
| Location | The UE location | Optional | Yes | UE |
| Criteria | where the matching | | | context |
| | traffic is allowed. | | | |
| | The RSD rule is not | | | |
| | considered to be | | | |
| | valid if the UE | | | |
| | location does not | | | |
| | match the location | | | |
| | criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
When the PDU Session Type is “Ethernet” or “Unstructured”, this component shall be present.

Like the last embodiment, a Multi-Path preference may be used in this embodiment. Further, in this embodiment, however, the Multi-Path preference indicates that a Layer-3 UE-to-Network Relay (rather than a Layer-2 UE-to-Network Relay) is preferred. The ProSe Layer-3 UE-to-Network Relay Offload indication: indicates that the traffic of the matching application is to be sent via a ProSe Layer-3 UE-to-Network Relay outside of a PDU Session when the rule is applied. If this indication is absent, then the traffic matching of the URSP rule is not sent via a ProSe Layer-3 UE-to-Network Relay outside of a PDU Session. If this component is present without the Multi-Path preference indication in a Route Selection Descriptor, no other components are included in the Route Selection Descriptor. If this component is present with the Multi-Path preference indication in a Route Selection Descriptor, other components can be included in the Route Selection Descriptor.

Multi-Path preference: If the UE is to establish PDU Sessions, the UE indicates such operations via the direct Uu interface and Layer-3 UE-to-Network Relay is preferred.

When the UE has a Layer-3 UE-to-Network Relay path available and establishes a PDU Session, the UE evaluates the matched URSP rule for application traffic and decides whether to use Multi-Path PDU Session for the application traffic based on the ProSe Layer-3 UE-to-Network Relay Offload indication and Multi-Path preference in the Route Selection Descriptor of a URSP rule. If the Multi-Path preference is present in the URSP rule, the UE further evaluates either ProSe Policy or Route Selection components in the URSP rule to establish/associate a PDU Session to a communication path via the Uu interface or Layer-3 UE-to-Network Relay.

In some embodiments, the URSP may be used for multipath transmission via 5G ProSe Layer-3 UE-to-Network Relay outside of a PDU session and over Uu reference point or either path. The URSP rule may include a traffic descriptor that specifies the matching criteria and a ProSe Multi-path Preference that indicates to the UE whether a matching application is preferred to be routed via multipath (i.e., via a PDU Session over Uu reference point and via ProSe Layer-3 UE-to-Network Relay outside of a PDU Session). In this case, if the ProSe Multi-path Preference indication is present in a Route Selection Descriptor, the ProSe Layer-3 UE-to-Network Relay Offload indication may not be included in the Route Selection Descriptor.

The ProSe Multipath Preference indication may also indicate that the traffic of the matching application is preferred to be sent via a PDU Session over the Uu reference point and a ProSe Layer-3 UE-to-Network Relay without N3IWF outside of a PDU Session. The traffic of the matching application may be sent via a PDU session over Uu reference point or via ProSe Layer-3 UE-to-Network Relay outside of a PDU Session when one of the paths is not available. If this indication is absent and the ProSe Layer-3 UE-to-Network Relay Offload indication is absent, then the traffic matching of the URSP rule may not be sent via a ProSe Layer-3 UE-to-Network Relay outside of a PDU Session. If this component is present in a Route Selection Descriptor, other components can be included in the Route Selection Descriptor to determine the PDU Session over the Uu reference point.

The Route Selection Descriptor of a URSP rule is only considered valid if the ProSe Multipath Preference indication is present and the UE supports the ProSe capability of 5G ProSe Layer-3 Remote UE.

Accordingly, if an application or application traffic matches a URSP rule, corresponding RSDs is used to evaluate the existing PDU sessions, establish a new PDU session, or determine to offload outside of a PDU session, or multipath transmission via 5G ProSe Layer-3 UE-to-Network Relay outside of a PDU session and a PDU Session over Uu reference point. Thus, if the selected RSD contains “ProSe Multi-path Preference”: the 5G ProSe Remote UE is preferred to route the traffic over a PC5 connection with a 5G ProSe Layer-3 UE-to-Network Relay and a PDU Session matched to other components (e.g., Network Slice Selection) in the selected RSD. If either connection is not available, then the traffic may be routed via a PC5 connection with a 5G ProSe Layer-3 UE-to-Network Relay or a PDU Session matched to other components. If the PC5 connection with 5G ProSe Layer-3 UE-to-Network Relay is not available, this may trigger the 5G ProSe Remote UE to start 5G ProSe UE-to-Network Relay discovery and connection establishment, controlled by the ProSe Policy configured on the 5G ProSe Remote UE. If the PDU Session matched to other components in the selected RSD is not available, this may trigger the establishment of a new PDU Session over Uu reference point using the values specified by the selected RSD.

### Embodiment 4:6.1.4 Procedure Enhancement for Multi-Path Policy Provisioning to a 5G ProSe Remote UE

For PCF-based Service Authorization and Provisioning to a 5G ProSe Remote UE/UE-to-UE Relay, the Registration procedures as defined in clause 4.2.2.2 of TS 23.502, UE Policy Association Establishment procedure as defined in clause 4.16.11 of TS 23.502 and UE Policy Association Modification procedure as defined in clause 4.16.12 of TS 23.502 apply with the following additions:

If the UE supports Multi-path transmission and 5G ProSe capability as a Remote UE accessing UE-to-Network Relay and does not have a valid Multi-path policy, the UE includes a UE Policy Container indicating the Multi-path policy provisioning request during registration procedure.

If the UE indicates the Multi-path policy provisioning request in the UE Policy Container, the PCF determines whether to provision the Multi-path policy to the UE accessing Layer-2 or Layer-3 UE-to-Network Relay based on the received capability of the 5G ProSe Layer-2 or Layer-3 Remote UE from the AMF, as specified in clause 6.1.2.2.2 of TS 23.503, and the PCF provides the Multi-path policy to the UE by using the procedure as defined in clause 4.2.4.3 “UE Configuration Update procedure for transparent UE Policy Delivery” in TS 23.502.

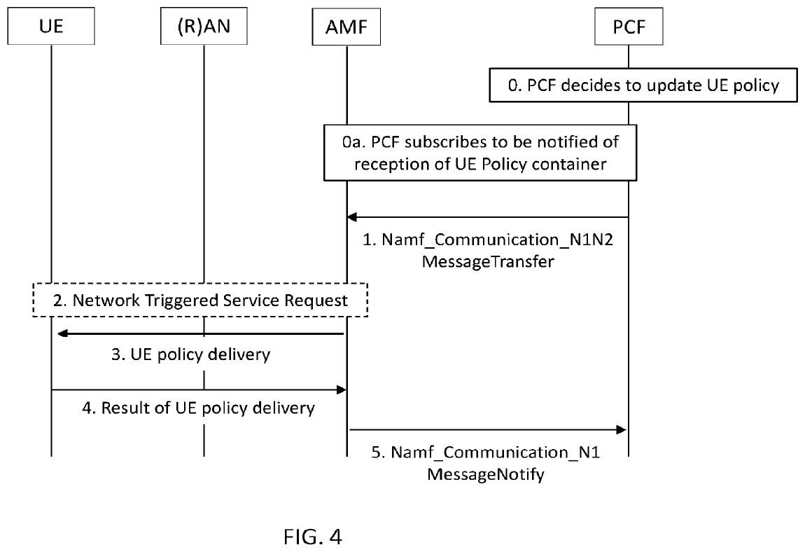

FIG. 4 illustrates a UE Configuration Update procedure in accordance with some embodiments. In the UE Configuration Update procedure for transparent UE Policy delivery shown in FIG. 4, at operation 0 the PCF decides to update UE policy based on triggering conditions such as an initial registration, registration with 5GS when the UE moves from EPS to 5GS, or updating UE policy based on: for initial registration and registration with 5GS when the UE moves from EPS to 5GS, the PCF compares the list of PSIs included in the UE policy information in Npcf_UEPolicyControl_Create request and determines, as described in clause 6.1.2.2.2 of TS 23.503, whether the UE policy information is to be updated and be provided to the UE via the AMF using DL NAS TRANSPORT message; and for a network-triggered UE policy update case (e.g. change of UE location, change of Subscribed S-NSSAIs as described in clause 6.1.2.2.2 of TS 23.503), the PCF checks the latest list of PSIs to decide which UE policies are to be sent to the UE.

The PCF checks if the size of the resulting UE policy information exceeds a predefined limit: if the size is under the limit, then UE policy information is included in a single Namf_Communication_N1N2 MessageTransfer service operation as described below: if the size exceeds the predefined limit, the PCF splits the UE policy information in smaller, logically independent UE policy information ensuring the size of each is under the predefined limit. Each UE policy information is then sent in separate Namf_Communication_NIN2MessageTransfer service operations as described below. The mechanism used to split the UE policy information is described in TS 29.507.

At operation 0a, if the PCF has not subscribed to be notified by the AMF about the UE response to an update of UE policy information, the PCF subscribes to the AMF to be notified about the UE response to an update of UE policy information.

At operation 1, the PCF invokes the Namf_Communication NIN2MessageTransfer service operation provided by the AMF. The message includes SUPI, UE Policy Container.

At operation 2, if the UE is registered and reachable by the AMF in either 3GPP access or non-3GPP access, the AMF transparently transfers the UE Policy container to the UE via the registered and reachable access.

If the UE is registered in both 3GPP and non-3GPP accesses and reachable on both access and served by the same AMF, the AMF transparently transfers the UE Policy container to the UE via one of the accesses based on the AMF local policy.

If the UE is not reachable by the AMF over both 3GPP access and non-3GPP access, the AMF reports to the PCF that the UE Policy container could not be delivered to the UE using Namf_Communication_N1N2 TransferFailureNotification as in operation 5 in clause 4.2.3.3.

If AMF decides to transparently transfer the UE Policy container to the UE via 3GPP access, e.g. the UE is registered and reachable by the AMF in 3GPP access only, or if the UE is registered and reachable by the AMF in both 3GPP and non-3GPP accesses served by the same AMF and the AMF decides to transparently transfer the UE Policy container to the UE via 3GPP access based on local policy and the UE is in CM-IDLE and reachable by AMF in 3GPP access, the AMF starts the paging procedure by sending a Paging message described in the step 4b of Network Triggered Service Request (in clause 4.2.3.3). Upon reception of paging request, the UE initiates the UE Triggered Service Request procedure (clause 4.2.3.2).

At operation 3, if the UE is in CM-CONNECTED over 3GPP access or non-3GPP access, the AMF transfers transparently the UE Policy container (UE policy information) received from the PCF to the UE. The UE Policy container includes the list of Policy Sections as described in TS 23.503.

At operation 4, the UE updates the UE policy provided by the PCF and sends the result to the AMF.

At operation 5, the AMF forwards the response of the UE to the PCF using Namf_Communication_N1MessageNotify.

The PCF maintains the latest list of PSIs delivered to the UE and updates the latest list of PSIs in the UDR by invoking Nudr_DM_Update (SUPI, Policy Data, Policy Set Entry, updated PSI data) service operation.

If the PCF is notified about UE Policy delivery failure from the AMF, the PCF may initiate UE Policy Association Modification procedure to provide a new trigger “Connectivity state changes” in Policy Control Request Trigger of UE Policy Association to AMF as defined in clause 4.16.12.2. The PCF may re-initiate the UE Configuration Update procedure for transparent UE Policy delivery as in operation 1 when the PCF is notified of the UE connectivity state changed to CONNECTED.

Note that each of the 3GPP TS specifications described herein is incorporated by reference in its entirety.

### Examples

Example 1 is an apparatus for a user equipment (UE), the apparatus comprising: memory; and processing circuitry, to configure the UE to: send, to a policy control function (PCF), a multi-path policy provisioning request in a UE Policy Container (UPC): receive, from the PCF, a UE route selection policy (URSP) that includes, URSP rules, at least one of the URSP rules indicating a Proximity-Based Service (ProSe) multi-path preference; and dependent on whether a packet data unit (PDU) session is to be established, establish a multi-path session based on the at least one of the URSP rules and path availability; and wherein the memory is configured to store the URSP rules.

In Example 2, the subject matter of Example 1 includes, wherein the processing circuitry configures the UE to establish, for the multi-path session, paths to that include a Layer-2 UE-to-Network Relay between the UE and a 5th generation NodeB (gNB) and direct Uu interface access between the UE and the gNB.

In Example 3, the subject matter of Examples 1-2 includes, wherein the multi-path preference is provided in a Route Selection Descriptor of the at least one of the URSP rules.

In Example 4, the subject matter of Example 3 includes, wherein the multi-path preference is provided in an access type preference parameter of the Route Selection Descriptor of the at least one of the URSP rules, the access type preference parameter selectable from a group of preferences that include 3GPP access, non-3GPP access, Multi-Access access, and Multi-Path access.

In Example 5, the subject matter of Examples 3-4 includes, wherein the multi-path preference is provided in a multi-path parameter of the Route Selection Descriptor of the at least one of the URSP rules, the multi-path parameter indicating preference of a multi-path session that includes a first path that provides direct Uu interface access between the UE and a 5th generation NodeB (gNB) and a second path having a Layer-2 UE-to-Network Relay between the UE and the gNB.

In Example 6, the subject matter of Examples 1-5 includes, wherein the processing circuitry configures the UE to: evaluate the URSP rules to find a matching URSP rule for application traffic for the PDU session, and determine whether to use the multi-path session for the application traffic based on one of an access type preference parameter or a multi-path parameter in a Route Selection Descriptor of the matching URSP rule.

In Example 7, the subject matter of Example 6 includes, wherein the multi-path session includes a first path that provides direct Uu interface access between the UE and a 5th generation NodeB (gNB) and a second path having a Layer-2 UE-to-Network Relay between the UE and the gNB.

In Example 8, the subject matter of Examples 6-7 includes, wherein: the multi-path session includes a first path that provides direct Uu interface access between the UE and a 5th generation NodeB (gNB) and a second path having a Layer-3 UE-to-Network Relay between the UE and the gNB, and the processing circuitry configures the UE to determine whether to use the Layer-3 UE-to-Network Relay based on a ProSe Multi-path preference.

In Example 9, the subject matter of Examples 6-8 includes, wherein the processing circuitry configures the UE to determine: whether the Route Selection Descriptor includes a ProSe Multi-Path preference parameter, and whether to use the ProSe Multi-Path PDU Session for the application traffic based on the ProSe Multi-Path preference parameter in the Route Selection Descriptor.

In Example 10, the subject matter of Example 9 includes, wherein in response to a determination that the ProSe Multi-Path preference parameter is present in the Route Selection Descriptor, the processing circuitry configures the UE to evaluate at least one of ProSe Policy or Route Selection components in the matching URSP rule to establish or associate the multi-path session to a communication path via a Uu interface or Layer-3 UE-to-Network Relay.

In Example 11, the subject matter of Examples 1-10 includes, wherein the Route Selection Descriptor contains only one of a ProSe Multi-Path preference parameter or a ProSe Layer-3 UE-to-Network Relay Offload indication

In Example 12, the subject matter of Examples 1-11 includes, wherein in the processing circuitry configures the UE to send at least one of a registration request message or a UE policy provisioning request message that contains multi-path policy provisioning request.

Example 13 is an apparatus for a policy control function (PCF), the apparatus comprising: memory; and processing circuitry, to configure the PCF to: receive, from a user equipment (UE), a multi-path policy provisioning request in a UE Policy Container (UPC); and send, to the UE, a UE route selection policy (URSP) that includes, a URSP rule, the URSP rule having a Route Selection Descriptor with a Proximity-Based Service (ProSe) multi-path preference, a multi-path session established based on the URSP rule and path availability; and wherein the memory is configured to store the URSP rule.

In Example 14, the subject matter of Example 13 includes, wherein the multi-path preference is provided in an access type preference parameter selectable from a group of preferences that include 3GPP access, non-3GPP access, Multi-Access access, and Multi-Path access.

In Example 15, the subject matter of Examples 13-14 includes, wherein the multi-path preference is provided in a multi-path parameter indicating preference of a multi-path session that includes a first path that provides direct Uu interface access between the UE and a 5th generation NodeB (gNB) and a second path having a Layer-2 UE-to-Network Relay between the UE and the gNB.

In Example 16, the subject matter of Examples 13-15 includes, wherein: the Route Selection Descriptor includes a ProSe Layer-3 UE-to-Network Relay Offload indication parameter, the multi-path session includes a first path that provides direct Uu interface access between the UE and a 5th generation NodeB (gNB) and a second path having a ProSe Layer-3 UE-to-Network Relay between the UE and the gNB, and use of the Layer-3 UE-to-Network Relay out of a packet data unit (PDU) Session is based on a ProSe policy for access authorization to the Layer-3 UE-to-Network Relay.

In Example 17, the subject matter of Examples 13-16 includes, wherein in the processing circuitry configures the PCF to receive from the UE a registration request message that contains multi-path policy provisioning request.

In Example 18, the subject matter of Examples 13-17 includes, wherein in the processing circuitry configures the PCF to receive from the UE a UE policy provisioning request message that contains multi-path policy provisioning request.

Example 19 is a computer-readable storage medium that stores instructions for execution by one or more processors of a user equipment (UE), the one or more processors to configure the UE, when the instructions are executed: send, to a policy control function (PCF), a Proximity-Based Service (ProSe) multi-path policy provisioning request in a UE Policy Container (UPC); receive, from the PCF, a UE route selection policy (URSP) that includes, a URSP rule, the URSP rule having a Route Selection Descriptor with a ProSe multi-path preference; and determine whether to establish a multi-path session based on the URSP rule and path availability.

In Example 20, the subject matter of Example 19 includes, wherein the multi-path preference is provided in one of: an access type preference parameter selectable from a group of preferences that include 3GPP access, non-3GPP access, Multi-Access access, and Multi-Path access, or a multi-path parameter indicating preference of a multi-path PDU session that includes a first path that provides direct Uu interface access between the UE and a 5th generation NodeB (gNB) and a second path having a Layer-2 UE-to-Network Relay between the UE and the gNB.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show; by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-40. (canceled)

41. An apparatus for a user equipment (UE), the apparatus comprising:
processing circuitry configured to:
decode, from a policy control function (PCF), a UE route selection policy (URSP) that includes URSP rules, at least one of the URSP rules indicating a multi-path preference;
determine, based on the at least one of the URSP rules, that traffic of a matching application is preferred to be routed via multi-path; and
based on a determination that traffic of the matching application is preferred to be routed via multi-path, encode the traffic of the matching application for transmission via a packet data unit (PDU) Session over a Uu reference point and a Layer-3 UE-to-Network Relay outside of the PDU Session; and
memory configured to store the URSP rules.

42. The apparatus of claim 41, wherein the Layer-3 UE-to-Network Relay outside of the PDU Session is a Proximity-Based Service (ProSe) Layer-3 UE-to-Network Relay outside of the PDU Session and the multi-path preference is a ProSe multi-path preference.

43. The apparatus of claim 42, wherein the ProSe multi-path preference is provided in a Route Selection Descriptor of the at least one of the URSP rules.

44. The apparatus of claim 43, wherein the Route Selection Descriptor further comprises an Access Type preference parameter that indicates an Access Type on which the PDU Session for the matching application is to be established, the Access Type being one of 3GPP, non-3GPP, or Multi-Access.

45. The apparatus of claim 44, wherein the Route Selection Descriptor further comprises a ProSe multi-path preference parameter that contains the ProSe multi-path preference, the Access Type parameter, and a ProSe Layer-3 UE-to-Network Relay Offload indication parameter.

46. The apparatus of claim 43, wherein the Route Selection Descriptor is only considered valid if the ProSe multi-path preference is present and the UE supports a ProSe capability of 5G ProSe Layer-3 Remote UE.

47. The apparatus of claim 41, wherein the processing circuitry is configured to:
evaluate the URSP rules to determine whether the at least one of the URSP rules is applicable for traffic of the matching application;
determine whether an existing PDU Session matches all components in a Route Selection Descriptor of the at least one of the URSP rules; and
in response to a determination that the existing PDU Session matches all components in the Route Selection Descriptor of the at least one of the URSP rules, route the traffic of the matching application on the existing PDU Session.

48. The apparatus of claim 41, wherein the processing circuitry is configured to:
evaluate the URSP rules to determine whether the at least one of the URSP rules is applicable for traffic of the matching application;
determine whether an existing PDU Session matches all components in a Route Selection Descriptor of the at least one of the URSP rules; and
in response to a determination that no existing PDU Session matches all components in the Route Selection Descriptor of the at least one of the URSP rules, establish a new PDU Session using parameters specified by the Route Selection Descriptor to route the traffic of the matching application on the new PDU Session.

49. The apparatus of claim 41, wherein the processing circuitry is configured to indicate a fifth generation (5G) Proximity-Based Service (ProSe) Capability during registration and the multi-path preference is a ProSe multi-path preference.

50. The apparatus of claim 41, wherein the processing circuitry is configured to:
determine that one of the PDU Session over the Uu reference point or the Layer-3 UE-to-Network Relay outside of the PDU Session is not available; and
in response to a determination that one of the PDU Session over the Uu reference point or the Layer-3 UE-to-Network Relay outside of the PDU Session is not available, encode the traffic of the matching application for transmission via another of the PDU Session over the Uu reference point or the Layer-3 UE-to-Network Relay outside of the PDU Session.

51. The apparatus of claim 41, wherein the processing circuitry is configured to:
determine that each of a multi-path preference and a ProSe Layer-3 UE-to-Network Relay Offload indication is absent in at least one other of the URSP rules; and
in response to a determination that each of the multi-path preference and the ProSe Layer-3 UE-to-Network Relay Offload indication is absent in the at least one other of the URSP rules, encode traffic matching the at least one other of the URSP rules for transmission via another PDU Session over the Uu reference point and not a ProSe Layer-3 UE-to-Network Relay outside of a PDU Session.

52. A non-transitory computer-readable storage medium that stores instructions for execution by one or more processors of a user equipment (UE), the one or more processors configured to, when the instructions are executed:
decode, from a policy control function (PCF), a UE route selection policy (URSP) that includes URSP rules, at least one of the URSP rules indicating a multi-path preference;
determine, based on the at least one of the URSP rules, that traffic of a matching application is preferred to be routed via multi-path; and
based on a determination that traffic of the matching application is preferred to be routed via multi-path, encode the traffic of the matching application for transmission via a packet data unit (PDU) Session over a Uu reference point and a Layer-3 UE-to-Network Relay outside of the PDU Session.

53. The non-transitory computer-readable storage medium of claim 52, wherein the Layer-3 UE-to-Network Relay outside of the PDU Session is a Proximity-Based Service (ProSe) Layer-3 UE-to-Network Relay outside of the PDU Session and the multi-path preference is a ProSe multi-path preference.

54. The non-transitory computer-readable storage medium of claim 53, wherein the ProSe multi-path preference is provided in a Route Selection Descriptor of the at least one of the URSP rules.

55. The non-transitory computer-readable storage medium of claim 54, wherein the Route Selection Descriptor further comprises an Access Type preference parameter that indicates an Access Type on which the PDU Session for the matching application is to be established, the Access Type being one of 3GPP, non-3GPP, or Multi-Access.

56. The non-transitory computer-readable storage medium of claim 55, wherein the Route Selection Descriptor further comprises a ProSe multi-path preference parameter that contains the ProSe multi-path preference, the Access Type parameter, and a ProSe Layer-3 UE-to-Network Relay Offload indication parameter.

57. The non-transitory computer-readable storage medium of claim 54, wherein the Route Selection Descriptor is only considered valid if the ProSe multi-path preference is present and the UE supports a ProSe capability of 5G ProSe Layer-3 Remote UE.

58. The non-transitory computer-readable storage medium of claim 50, wherein the one or more processors are configured to, when the instructions are executed:
evaluate the URSP rules to determine whether the at least one of the URSP rules is applicable for traffic of the matching application;
determine whether an existing PDU Session matches all components in a Route Selection Descriptor of the at least one of the URSP rules;
in response to a determination that the existing PDU Session matches all components in the Route Selection Descriptor of the at least one of the URSP rules, route the traffic of the matching application on the existing PDU Session; and
in response to a determination that no existing PDU Session matches all components in the Route Selection Descriptor of the at least one of the URSP rules, establish a new PDU Session using parameters specified by the Route Selection Descriptor to route the traffic of the matching application on the new PDU Session.

59. An apparatus for a policy control function (PCF), the apparatus comprising:
processing circuitry configured to:
encode, for transmission to a user equipment (UE), a UE route selection policy (URSP) that includes URSP rules, at least one of the URSP rules indicating a multi-path preference indicating that traffic of a matching application is preferred to be routed via multi-path via a packet data unit (PDU) Session over a Uu reference point and a Layer-3 UE-to-Network Relay outside of the PDU Session; and
memory configured to store the URSP rules.

60. The apparatus of claim 59, wherein:
the Layer-3 UE-to-Network Relay outside of the PDU Session is a Proximity-Based Service (ProSe) Layer-3 UE-to-Network Relay outside of the PDU Session and the multi-path preference is a ProSe multi-path preference, and
the ProSe multi-path preference is provided in a Route Selection Descriptor of the at least one of the URSP rules.
